(19) United States
(12) Patent Application Publication
(10) Pub. No.: US 2014/0258243 A1
(43) Pub. Date: Sep. 11, 2014

(54) ONLINE SYSTEM, APPARATUS, AND METHOD FOR OBTAINING OR APPLY FOR INFORMATION PROGRAMS, SERVICES AND/OR PRODUCTS

(71) Applicant: APPLYRAPID, INC., Camden, NJ (US)

(72) Inventor: Donta' D. Bell, Marlton, NJ (US)

(73) Assignee: APPLYRAPID, INC., Camden, NJ (US)

(21) Appl. No.: 14/351,046

(22) PCT Filed: Oct. 10, 2012
(86) PCT No.: PCT/US12/59595

§ 371 Date: Apr. 10, 2014

Related U.S. Application Data
(60) Provisional application No. 61/545,680, filed on Oct. 11, 2011.

(51) Int. Cl. G06F 17/30

(52) U.S. Cl. CPC G06F 17/30345; G06F 17/30371; G06F 17/30424
USPC 707/690; 707/736

(57) ABSTRACT

Methods, systems, and apparatuses, including computer programs encoded on computer-readable media, for receiving, from a user, user data associated with one or more fields of a user profile associated with the user. The user profile includes a plurality of predefined fields. A request to create a requisition is received from a producer. The request includes requisition fields that include one or more of the plurality of predefined fields of the user profile. A request for the requisition is received via a smart link from the user. Requisition user data from the user profile corresponding to the requisition fields is determined. The requisition user data includes a portion of the received user data. The requisition and the requisition user data are sent to the user. An indication giving permission for the producer to access the requisition user data is received. The requisition user data is provided to the producer.

This application claims the benefit of U.S. Provisional Application No. 61/545,680, filed Oct. 11, 2011, the contents of which are incorporated herein by reference in its entirety.

### BACKGROUND

Internet browsers of today generally display forms by rendering Hyper Text Markup Language (HTML) to produce fields arranged in a format that can be populated by a consumer or user. Hypertext is text with hyperlinks, and a hyperlink (or link) is a word, group of words, icon, or image that is a reference to a document that the reader can follow directly, or that is followed automatically. A hyperlink can point to a whole document or to a specific element within a document. A software system for viewing and creating hypertext is a hypertext system, and to create a hyperlink is to hyperlink (or simply to link). A user following hyperlinks is said to navigate or browse the hypertext. A hyperlink generally has an anchor, which is the location within a document from which the hyperlink can be followed; the document containing a hyperlink is known as its source document. The target of a hyperlink is the document, or location within a document, to which the hyperlink leads. Users can activate and follow the link when its anchor is shown, usually by touching or clicking on the anchor with a pointing device.

Today's hyperlinks are static. They do not store information or manage criteria used to execute a procedure. Hyperlinks simply direct you to a destination or a process. Currently, links pass session variables as information or criteria embedded in browser URLs (uniform resource locator).

Most web sites on the internet, intranet, or worldwide web use online forms created using hypertext and/or hyperlinks to capture information, for example to process shopping orders, loan applications, college applications and the like. The current scenario for a user wishing to apply, register, or enroll for something online involves clicking on a link which brings him/her to a form with fields into which the user enters information such as a name, birth date, password, and the like. The user has to repeatedly enter this information each time he/she visits a new web site to apply, enroll, purchase, or register. In some cases the user has to repeatedly enter information on web sites previously visited particularly for web sites where data entered on their form is not retained for future use despite the fact that the information entered by the user is captured on the web site regarding the prior transaction. Having to repeatedly enter the same or similar information can be time consuming, burdensome and in some instances may deter a user from applying, registering or enrolling online. Additionally, as time passes information (e.g., address, phone number, number of children, marital status) may change which generally results in the user repeatedly being asked to update the information by two or more entities.

Most of the information (e.g., name, address, phone number, etc.) requested in on line forms is redundant or can be obtained from other sources. However, because these forms are created and/or formatted differently from web site to web site or vendor to vendor there is no way to easily share or communicate the information previously entered by the user on an earlier or different form. To compound this problem, privacy issues from an organizational, personal and/or legal perspective have made it difficult to develop and provide workable solutions for information sharing between web sites.

There are many techniques to re-populate and auto-fill forms on the internet Some techniques pre-populate automatically via the browser, pre-populate from the user's command, or from other systems. The problem with pre-population is that the personal data is not always secured especially if the data is being passed and stored via URL's, session variables, cached browser data, and other methods. One example of an attempt to eliminate or reduce the amount of times a user has to input the same or similar information into an online form is seen with “cookies”. Although “cookies” (small data files stored by a web site on the uses local computer) are used to retain information locally that can be recalled later by a web site that the user has previously used these, “cookies” tend to vary greatly from web site to web site. Use of “cookies” also requires web designers to include special logic on web sites to recognize previous users that have visited the site which can be cumbersome. Additionally, users can block the storage of “cookies” by web sites that they are unfamiliar with and/or do not trust.

Another attempt to eliminate or reduce the amount of times a user has to input the same or similar information into an online form is seen with Microsoft's Microsoft Internet Explorer product which has a “profile assistant” feature that allows web sites to retrieve frequently used information such as user name, address, and the like that was stored securely in protected storage on the user's computer after the user had previously entered the information while visiting the web site, Although the “profile assistance” did offer a solution it was still not without problems. Use of the “profile assistant” meant that in order to get access to the information the web servers had to have, for example, Microsoft's Microsoft Internet Explorer 4.0 product. If the web site did not have this product the user's information could not be accessed. Also, the “profile assistant” required that each web site write script to request information from the user's stored information which could lead to different or unwanted user responses, depending on what was in the script.

The “vCard” is another approach to improving the electronic personal data exchange process. The “vCard” system creates standardized field identifiers that are used for the same data fields and facilitates the transfer of personal profile information among applications. However, the problem with this tool is that it is primarily a standard for representing contact information that forces millions of web sites to conform to standard field identifiers or to retrofit existing web pages to the existing “vCard” format.

There are hundreds of thousands of producers offering goods, services and products on line. When consumers apply, enroll, purchase, and/or register for those services, goods and/or products electronically an on-line form must be completed. Generally, each web site has its own way of enabling consumers to apply, enroll or register for its goods, services or products, and its own way of displaying data and results. A consumer wishing to accept an offering or query from one or more producers, will have to complete an on-line form for each service, good or product of interest, which can be redundant as it relates to reentering details into data entry screens of the various web sites and burdensome regarding following the flow of different information capturing processes. Because the consumer has to remember usernames and/or passwords from each web site frustration and lost opportunities may also result from the variability that exists with different websites regarding the requirement of username and password for authentication.

Consumers or users spend a great deal of time and effort searching, for goods, products and services (e.g., jobs, schools, recreation programs, athletic programs, clubs, loans, scholarships, etc.) Likewise, producers of goods, products and services (e.g., employers, schools, foundations, organizations, businesses, clubs, etc.) expend huge sums of money, resources, and time seeking out consumers for its offerings. Producers also include consultants, freelancers, recruiters, head hunters, employment agencies, personal agents, personal managers, and/or other intermediaries who or which in many cases serve as the connection between the parties to assist in establishing a dialog between parties, making introductions, and developing relationships such as employer-employee relationship.

In the case of producers such as employers, schools, city, state and/or national government, colleges, universities, clubs, organizations and the like, the need to find and/or recruit employees, members, students and the like, with skills, backgrounds, and/or the educational caliber to meet their business, academic and/or organizational needs occurs very often. Recruitment efforts typically require producers such as colleges to do one or more of the following: search for likely candidates, information gather, pre-screen potential candidates, introduce parties to one another, exchange information in order to determine if a relationship is appropriate and/or desirable, negotiate, complete an agreement between the parties, etc. Any one or more of these activities can be done by the employers, schools, colleges, universities, clubs, organization and the like, itself or through an agent such as a headhunter, which is usually at a great expense. In either case, recruitment efforts may be limited or constrained by limited geographical, monetary and/or time limitations. This may be true even if a headhunter, recruiter, employment agency or the like is enlisted, particularly in the case where the headhunter, etc., is working with similar limitations and/or constraints. Recruitment efforts may be further constrained when the employee, member, and/or student is not properly pre-screened and/or properly informed as to the needs and/or demands of the employers, schools, colleges, universities, clubs, and/or organization.

At any given time there may be thousands of consumers applying for, and/or inquiring about a recruitment opportunity. Because of the huge number of potential consumer expressing interest in the opportunity it may take many hours to review and/or search through each application and/or inquiry to cull through and obtain a list of select candidates. Securing, storing, maintaining and managing the thousands of files and/or documents generated from one or more recruitment opportunities is another recruitment constraint because of the cost and time associated with these activities.

Confidentiality is another concern that may limit recruitment efforts. An employer, school, college, university, club, organization etc., may have an interest in, and/or a desire for, maintaining confidentiality or anonymity during some parts of a job search or recruitment effort, particularly in the early stages. Once an interest is expressed some or all of the confidentiality and/or anonymity may be lost for the remainder of the process.

Typically, when searching for an employer, school, college, university, club, organization and the like, the consumer has to search various databases, register using different login credentials, navigate various application processes for each web site and enter similar or the same information into data entry fields for each web site. As there are thousands for example, employers, and thus multiples of thousands of jobs, on various databases, job seekers face several challenges in trying to find the job they are looking for without spending a huge amount of time and money by this process. Confidentiality is also a concern of most consumers particularly as it relates to how much and when information is shared particularly in the early stages.

### SUMMARY

Various implementations provide systems and methods for eliminating or reducing the need for a consumer having to repeatedly input previously provided data and/or information when creating or completing online forms for each producer requiring such online form when attempting to apply, enroll, join, purchase, obtain information, and/or register for services, goods, information, and/or products. In some implementations, systems and methods provide for producers and/or consumers to communicate and share current data and/or information without having to repeatedly inputting data and/or information already stored in a central computer processing unit. In some implementations, customizable smart links that contain producer created and stored information, rules and/or criteria, that can be used to cross reference consumer information repositories to target qualified potential candidates for programs and/or offerings by a producer are used.

One implementation relates to systems and methods for providing a secure electronic, mobile, cloud-based and customizable distributed interface via a custom smart link that once activated allows consumers of goods, services, information, and/or products to easily share, exchange, apply, and receive real-time and up-to-date data and/or information when desired, or required by one or more producers of consumer goods, information, services, and/or products without the consumer having to repeatedly input data and/or information previously submitted and stored by utilizing custom smart links.

In one aspect the secure electronic, mobile and cloud-based customizable distributed interface is created, managed, and integrated or linked with one or more custom smart links by the producer. Each custom smart link links to one or more customizable requisitions created and defined by the producer selecting from thousands of pre-defined terms and/or options made available in one or more data link repositories in a central processing computer. After creation, each customizable requisition can be linked to and/or integrated with one or more custom smart links. The custom smart links linking to one or more requisitions can be—distributed (and thereby activated) throughout various, communication systems and/or networks such as the internet, worldwide web, blogs, websites, mobile communication systems, and the like. Each smart link and requisition can be managed (e.g., updated, modified, deleted, suspended, etc.) by producers at any time and any place using any available communication network. Producers can delay activating one or more custom smart links having a customized requisition until some future date, or never activate one or more smart links.

Each custom smart link can be integrated into a stand alone software application process (plug-in) or a computer processing unit that can, amongst other things, search, review, and analyze consumer information repositories and/or consumer profiles, verify and/or match criteria and/or parameters set by the customized requisition against consumer profiles; calculate consumer acceptance and/or approval probability based upon criteria/parameters set by the customized requisition; highlight, invite, and/or prompt consumer to supply missing data and/or information required by customized requisition; report on search results; invite consumers who meet criteria/parameters defined in customizable requisition to enroll, register, request, purchase, and/or apply for goods, services, information, and/or products; alert producers and consumers of opportunities based upon data and information stored in consumer information repositories, consumer profiles, producer information repositories and/or producer profiles; communicate consumer requests to producer, and the like or a combination thereof.

Thus, in this implementation, consumers can enroll, register, request, purchase, and/or apply for producers goods, services, information, and/or products simply by accessing the smart link or a hypertext and/or a hyperlink within the smart link for enrolling, registering, requesting, purchasing, and/or applying. Upon electing to enroll, register, request, purchase, and/or apply for producer's goods, services, information, and/or products the consumer's relevant data and information can be uploaded, stored, transferred, and the like, or a combination thereof, to the producer via an interface customized by the producer to begin and/or complete the online enrollment registration, requesting, purchasing, and/or application process.

Each custom smart link can also search, review, and analyze producer information repositories, producer profiles, and/or smart link database link repositories for data and/or information and/or requisitions of interest to consumers, report search results, request information for consumers, alert consumers of opportunities based upon data and information stored in producer information repositories and/or producer profiles; communicate consumer requests to producer, and the like and provide a summary or report of the search results, requested information, etc. The summaries, reports, etc., generated from the search and analysis can be displayed to the consumer via an interface customized and/or defined by the consumer.

In one implementation, the custom smart links can be a two way customizable system, whereby producers are able to customize requisitions and consumers can customize conditions under which (e.g., it when, how much, how long, and the format by which) their information is shared. The producer can create one or more same, similar, or different pre-defined requisitions and link or integrate them to one or more smart links that can be activated upon distribution to one or more websites, blogs, etc., as previously described. From the consumer's perspective, the custom smart link provides a means for the consumer to control what, if any, data and/or information is communicated, provided or requested to or from the producer, respectively. In the case of a consumer who already has a profile on the central processing computer, individual or consumer computer, and who desires to provide data and/or information requested or required by a producer, the custom smart link can serve as a means for the consumer to control what, when and how data and information will be shared, if at all, in the case where no consumer profile is stored on the central processing computer system or individual or consumer computer, the custom smart link can prompt the consumer to create and/or store a profile before proceeding.

The central processing computer system can retrieve a consumer or producer profile that is already stored on an individual's or consumer's computer, producer's computer, or on a website such as Facebook®, Livingsocial®, LinkedIn® and the like, by mapping and pulling appropriate data and/or information from these sources.

In another implementation, the custom smart link serves as an intermediary, gateway and/or portal between the consumer and producer to facilitate real time communication, and data and/or information sharing between the consumer and producer.

In yet another implementation, a producer can be a consumer and a consumer can be a producer.

In another implementation, systems or methods provide for secure and confidential transfer of data and/or information between consumer and producer whereby one or more custom smart links are controlled and managed via a central processing computer system. The central processing computer system includes, amongst other things, consumer data and/or information repositories (which can contain at least one consumer profile), and producer data and/or information repositories (which can contain at least one producer profile). Each of the consumer profiles and producer profiles can contain personal, proprietary, business and/or generalized data and information of the respective party. The central processing computer system can also have a means to access consumer data and information stored on an individual and/or consumer computer.

In another implementation, systems and methods for storing and/or distributing in a data link repository on the central processing computer system and/or distributing throughout a multitude of communication networks (e.g., producer website, third party websites, blogs, Facebook®, LinkedIn®, mobile application links, and the like) one or more activated custom smart links that provide a secure, seamless, and efficient process for consumers to apply, register, enroll, purchase, share, and/or request information from producers for or regarding their goods, services, information, and/or products without having to create a predefined form. The networks include but are not limited to systems where the internet, worldwide web can be accessed, such as mobile devices (e.g. smart phones, iPad®, Kindle®, Nook®, game consoles, handle games and the like).

Once the smart link is created it can then be tagged to one or more third party websites by using a unique identifier particular to the third party to embed the smart link within the third party's website.

In another implementation, a system or an apparatus distributes data and/or information of a consumer to one or more web sites that the consumer selects without the consumer having to repeatedly input previously entered data and/or information for the same and/or different web sites.

Various implementations includes a central processing computer having one or more repositories for storing at least one secured consumer created and stored profile; at least one producer created and stored requisition profile, at least one data link repository having one or more pre-defined and/or customizable requisition options, one or more data link repositories, and a means for creating, storing, managing, and activating one or more custom smart links containing producer created customized requisitions that facilitate communication, and/or data and/or information exchange between consumers and producers.

In another implementation, a method distributes requested and/or required data and/or information of a consumer to one or more web sites that the consumer selects without the consumer having to repeatedly input previously submitted data and information for each web site visited. In one aspect, a consumer that already has a profile on a central processing computer system, logs into its password-protected secure account, through a third party's website, blogs, etc., or the central processing computer system and clicks or points to an activated custom smart link. Once the link is initiated the consumer can be prompted or requested to provide a unique identifier for validation purposes. Non-limiting examples of unique identifiers are e-mail address, telephone number, cell phone number, pager number, password, pin number, security code, or a combination thereof. Once validated, the consumer can be prompted or requested to give producer access to data and/or information required by customizable requisition contained in the smart link. The consumer has the option to give producer access to all, some, or none of the requested and/or required data and/or information stored in the consumer's profile which can be located in a consumer information repository on the central processing computer system, or individual or consumer computer. Once the consumer grants the producer access to all, some, or none of the data and/or information the central processing computer system can capture the relevant data and/or information from consumer's profile for viewing and processing as granted by the consumer.

The central processing computer system can prompt and/or notify the consumer that application, registration, enrollment, purchasing, etc., is either completed, ready for processing, or that additional data and/or information is required before the transaction can be completed or processed. If prompted to provide additional data and/or information not already stored in the consumer's profile consumer can do so. In the case where the consumer does not grant access to, or fails to provide all of the data and/or information requested and/or required by the producer, the consumer will be prompted that the transaction cannot proceed and session will ultimately end.

In the case where no consumer profile is stored on the central processing computer system, individual or consumer computer, the consumer can be prompted to create and/or store a profile before proceeding.

In one implementation, after clicking on, or selecting a custom smart link the consumer is prompted or requested to provide an e-mail address and/or cell phone number as a unique identifier which is used to confirm consumer's intent to access and/or use the smart link before smart link session can proceed. In one implementation, the smart link cannot be used without consumer inputting an e-mail address and/or cell phone which can be used to verify the consumer's identity and intent to use the activated custom smart link

In another implementation, the custom smart link can translate all languages on demand to both the producer and consumer. For example, the producer can create the smart link in English and the consumer can respond to the smart link in Spanish. Because of the nature of pre-defined fields for requisitions options, consumer and producer profile options, smart link management options communications and/or applying for producer's goods, services, and/or products can be made in different languages as needed. The translations can be done by tying or linking the process to one or more translation programs or systems.

In one implementation, schools, associations, employers can use smart links in recruitment activities. Current methods for processing tens of thousands of applications for admission to schools involve manual and labor intensive processes, which can lead to unnecessary delays, reduced productivity, and human error (e.g. failure to log receipt of documents). In various implementations, consumer efficiency can be increased by eliminating or reducing the need to complete pre-defined on-line forms, and producer efficiency in processing applications, orders, requests, etc. Human intervention and errors in processing can also be reduced. In addition, application components via use of a consumer unique identifier can be tracked and the need to join diverse components or documents of one application by storing the relevant data and/or information contained in these documents in central processing computer systems or on individual or consumer computers is eliminated. The relevant data is also available as needed.

In another implementation, services are provided for the consumer such as job searches, school searches, organization searches and the like, and services for the producer such as candidate searches, applicant searches, and the like, while preserving confidentiality among and/or between the parties and/or between the parties and third parties. It may also provide varying layers of confidentiality for the parties involved. Various implementations may also provide enhanced information services for the consumer and producer using the same links, hyperlinks, and/or other pointing and/or linking devices for linking a producer to additional information about the consumer.

In some implementations, notice can be given to a prospective consumer of the availability and/or existence of an opportunity for and/or related to a job, position, school admission, scholarship, etc. Various implementations can be used to assist a producer searching for, or to notify a producer of a consumer with a stored profile that meets the criteria set forth in a requisition defined by the producer.

In one implementation, secured and targeted search and/or recruitment activities are facilitated and improved by providing a means for producers to search, pre-screen and pre-select consumers (candidates and/or applicants) for an available opportunity (e.g., college admission, grant, scholarship), position (e.g., job), membership (e.g., club, organization) and the like, based upon the data and/or information stored in consumer's information repository and thereafter providing a means for the producer to invite consumers to apply, register, enroll, and/or request information about the opportunity. This can significantly reduce the time and effort required to sift through thousands of applications, registrations, forms and the like, increases the chances that producers target the best candidates from an available pool of consumers, and at the same time reduces or eliminates geographical, and/or monetary constraints producers may have with currently available recruitment technologies. Thus, in some implementations, an apparatus or a method provide job searching services; recruitment services, recruitment-related services for schools, colleges, universities, and the like; financial services, business transaction services, and the like for any organization where appropriate.

In one implementation, notice can be provided to any consumer or producer when and/or if information is being and/or has been requested about he, she or it, and by who via transmitting notifications through communication networks such as e-mails, electronic messaging, paging, telephoning, etc. Automatic notice or announcements can be provided to any consumer when an opportunity (e.g., job opening, assignments, scholarships, projects, etc.) becomes available by transmitting notifications via communication networks as previously described herein. In addition, authorized or unauthorized access to any data and/or information concerning a consumer or producer can be blocked.

In another implementation, secured and targeted search activities can be facilitated and improved for consumers by providing a means to search, pre-screen and pre-select available opportunities of interest (e.g., college admission, grant, scholarship), position (etc., job), membership (etc., club, organization) and the like, based upon the data and/or information stored in a producer's information repository and thereafter providing a means for the consumer to apply, register, enroll, and/or request information about the opportunity.

In another implementation, all data and/or information obtained from the thousands of files and/or documents generated from and associated with one or more recruitment opportunities, or offers of goods, services, information and/or products can be stored and utilized. Thus, producers can elect to securely store and manage data and/or information on its own system only from consumers it has selected, enrolled, registered, approved, and/or communicated with.

In another implementation, search and/or recruitment activities for producers and/or consumers can be monitored, recorded, and/or tracked.

### BRIEF DESCRIPTION OF DRAWINGS

The details of one or more implementations of the subject matter described in this specification are set forth in the accompanying drawings and the description below. Other features, aspects, and advantages of the subject matter will become apparent from the description, the drawings, and the claims.

FIGS. 1 through 7 herein are provided for illustration purposes only and are not intended to be limiting.

FIG. 1 illustrates a system showing the connection between components of a smart link system in accordance with an illustrative implementation.

FIG. 2 illustrates a central computing system of the smart link system in accordance with an illustrative implementation.

FIG. 3 illustrates a data link repository in accordance with an illustrative implementation.

FIG. 4 illustrates the smart link processing system and some of its primary components in accordance with an illustrative implementation.

FIG. 5 illustrates how consumers and/or producers interact with smart links in accordance with an illustrative implementation.

FIG. 6 illustrates a sample Producer application interface with examples of consumer link classifications in accordance with an illustrative implementation.

FIG. 7 illustrates a sample Producer application interface with examples of business link classifications in accordance with an illustrative implementation.

### DETAILED DESCRIPTION

As described in greater detail, a requisition form can be created using predefined fields. For example, a requisition form can be created by selecting one or more of the predefined fields. In addition, matching criteria can be added to each field. As described in greater detail below, the matching criteria can be used to rank completed requisitions. The predefined fields correspond to fields in user profiles of various users. Each user may have provided data for one or more fields of their user profile. When a user accesses a requisition form, the user profile data can be used to pre-populate one or more fields of the requisition form. In one implementation, a user is only shown the fields of the requisition that are not pre-populated. The user, however, can choose to review all of the fields in the requisition that were automatically populated with data from the user's user profile. The user has the option of restricting access to any of their data. For example, a user can provide input, e.g., via activation of a user interface component, to indicate that a particular field is not to be sent as part of the completed requisition form. Accordingly, the user is in control of what information is sent to a creator of the requisition form. The requisition form can also include custom questions, which are questions that are not tied to data in a user profile. The answers to custom questions, therefore, are never automatically populated from user profile data. In addition, answers to custom questions are not stored in the user profile. Once the user has completed the requisition form, the user can submit the data and permission data. The permission data is used to determine the user data the creator of the requisition form can access.

Unless otherwise defined, all technical and scientific terms used herein have the same meaning as commonly understood by one of ordinary skill in the art.

The terms “custom smart link”, “smart link”, and “automated custom smart link” are used interchangeably. A smart link is a link to a previously created requisition form that can access profile data of users and/or businesses.

The term “activated smart link”, and “custom activated smart link” refer to a custom smart link, smart link, or an automated custom smart link, which links to a requisition for a particular offering or program, that has been distributed to one or more of the producer's web site who created the requisition and link, and/or third party web sites, including blogs, mobile networks and the like.

The term “unactivated smart link” refers to a custom smart link, a smart link, or an automated custom smart link, which links to a requisition for a particular offering or program, that has not been distributed to one or more of the creating producer's web site, and/or third party web sites, including blogs, mobile networks and the like.

The articles “a” and “an” as used herein refer to one or more than one of the object of the article.

The term “click” and “clicking” as used herein refer to a consumer or producer using a mouse, pointer, or any other device to access or activate a smart link, link, hyperlink, hypertext and the like.

The term “apply” as used herein with respect to a consumer's interest in producer's goods, services, information and/or products includes one or more of applying for, enrolling in, registering for, joining, purchasing, and/or requesting data and/or information data and/or information regarding the good, program, product, and/or service.

The term “processing” as used herein with respect to a computer or electronic processing means any process, algorithm, method, or the like, unless expressly specified otherwise. Each process inherently includes one or more acts necessary to complete a desired function or activity.

The terms “including”, “comprising”, and variations thereof mean “including but not limited to”, unless expressly specified otherwise.

The term “consumer” or “user” as used herein refers to any person, individual, group of people, organization, business, or entity that purchases, enrolls, registers, applies, and the like, for services, goods, information, products. Unlimited examples of consumers or users are individuals, contractors, freelancers, businesses, schools, clubs, and the like.

The term “producers” as used herein refers to entities, companies, schools, or individuals who offer services, goods, information, products and/or goods for free, at a cost or a combination thereof. Unlimited examples of producers are public and private schools including elementary, middle, high schools, home schooling programs, vocational or trade schools, school of the arts, post-secondary schools (e.g., colleges, universities, technology schools), employers, organizations, businesses, clubs, consultants, freelancers, recruiters, employment agencies, personal agents, personal managers, and the like.

The term “customizable requisition” or “requisition” as used herein is a producer created and defined offer or request to sell, enroll, provide, perform, request information, and the like, goods, services, information, and/or products, for free or at a cost to consumers who possess certain criteria. For example, a requisition seeking to find candidates with a molecular-engineering background might require that he or she has a PhD in the field, reside in California, worked in the field for 5 or more years, is willing to travel 30%, and the like. The criteria set forth by the producer may vary depending upon the employer, school, industry (e.g. banking, chemical, pharmaceutical, automobile, government) the need, timing, location, pay, etc. The requisition is created when the producer selects one or more options from an expandable repository of pre-defined requisition options, which are used to build a customized interface that is then linked to a custom smart link. The producer can further customize the requisition by using customization fields found in central processing computer system. The requisition can request general and/or specific data and/or information about and from the consumer and can target a specific demographic of consumers. The requisition can provide background information about the producer as well as more detailed data and/or information about the offer or request. An example of a requisition can be a standard purchase order or applications form generally seen in commerce.

The term “communication network” as used herein refers to the internet, intranet, the worldwide web, a telecommunications network, as well as any other communication network described herein or known in the industry. Communication between a consumer and producer may occur through any and all communications means including electronic message transmission, e-mail, electronic forms submissions, telephone (call and/or messaging), facsimile messaging, pager and/or beeper messaging, and/or any other appropriate electronic method, means and/or mechanism.

The term “consumer information repositories” as used herein refers to a database and/or repository that contain at least one profile of a consumer (consumer profile or user profile). The consumer profile can include data and/or information such as name, address, years of schooling, grades, college degrees, etc.

The term “producer information repositories” as used herein refers to a database and/or repository that contain at least one profile of a producer (producer profile). The producer profile can include data and/or information such as name, address, business goals, sales information, etc.

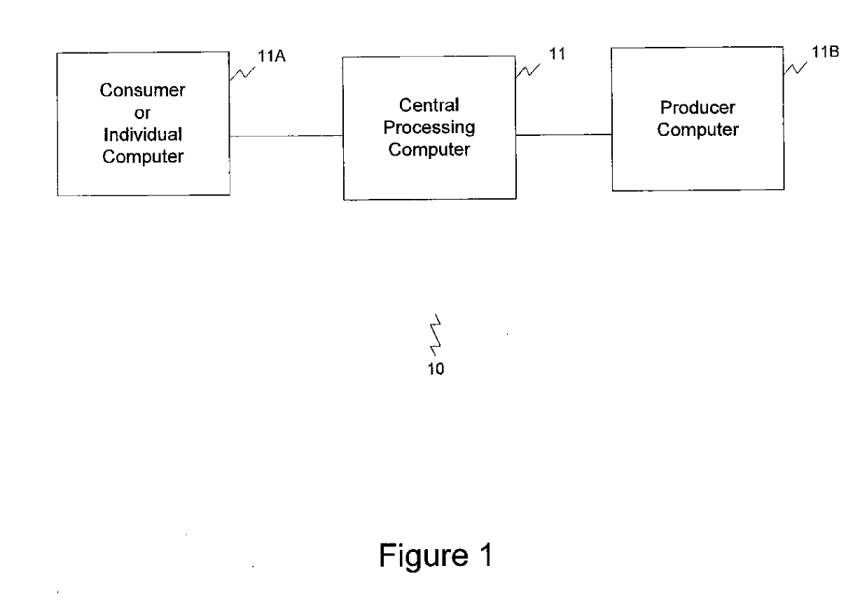

FIG. 1 illustrates a system showing the connection between components of a smart link system 10 in accordance with an illustrative implementation. The smart link system 10 includes one or more central processing computers 11 that can include user profiles and requisition forms. One or more central processing computers 11 can be linked or stand alone devices and can be dedicated to a geographic area, individual, group, entity, type of individuals or a mixture thereof.

The smart link system 10 can also include one or more consumer or individual computers 11A each of which can be a personal or individual computer or any communication device. The individual computers 11A and the central processing computers 11 can communicate using any network that allows two-way electronic communication. The smart link system 10 can also include one or more producer computers 11B, each of which can be a personal computer or any communication device. The producer computers 11B and the central processing computers 11 can communicate using any network that allows two-way electronic communication between central processing computer 11 and producer. Non-limiting examples of consumer or individual computers 11A and producer computers 11B can be one or more of computers such as handheld, laptop, personal, palmtop, etc.; a personal communication device, a personal digital assistant, telephone (e.g., digital telephone, display telephone, video telephone, videophone, 3G, 4G, 5G or later telephone, etc.), television, beeper, pager and/or watch.

Each consumer or individual computer 11A and each producer computer 11B, respectively, can transmit and receive information to and from each central processing computer 11. Each consumer or individual computer 11A and each producer computer 11B, respectively, can transmit and receive information from each other directly or indirectly.

The central processing computer 11, consumer or individual computer 11A and/or producer computer 11B can be linked, and information transmitted and received between them can occur over a wired and/or wireless communication network using equipment and/or devices that provide access to the internet, intranet, network systems and/or worldwide web. Suitable wired and/or wireless communication network systems can include, but not limited to, those involving telephone (e.g., cellular, digital); personal communication services, satellite, broadband, low earth orbiting, public switch telephone systems and the like. Each of the central processing computers 11, consumer or individual computers 11A and/or producer computers 11B can transmit data and/or information using any internet and/or worldwide web protocol such as TCP/IP and the like.

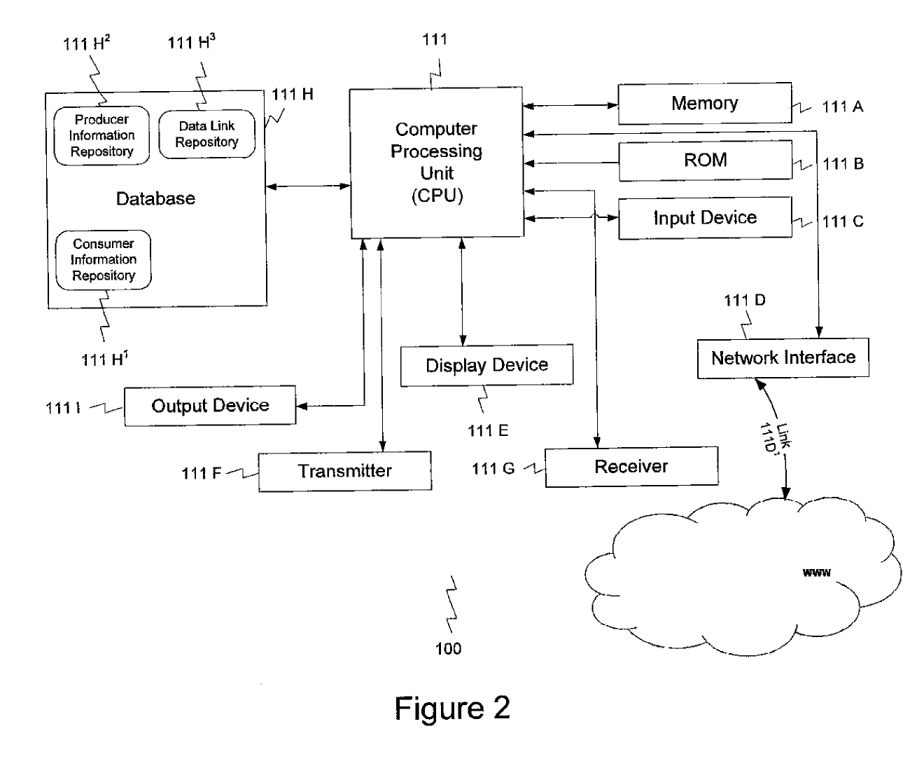

FIG. 2 illustrates a central computing system 100 of the smart link system in accordance with an illustrative implementation. The central computing system 100 includes a single computer processing unit (CPU) 111. However, the central computer system 100 can also be a multiprocessor system that can be networked and share resources such as memory and/or storage; a multiple server system where independent servers operate in parallel and optionally having shared access to searchable databases; or a combination thereof. The CPU 111 can be a microprocessor, microcomputer, minicomputer, macro-computer and/or a mainframe computer.

Connected to CPU 111 is a memory device 111A which can be any suitable memory such as SRAM, DRAM, SDRAM, RDRAM, DDR, DRR-2, and the like. Also connected to CPU 111 is a read only memory device 111B (ROM); an input device 111C for entering data and/or commands into computer system 100; a display device 111E for displaying data and/or information to a user or operator; and an output device 1111 (e.g., printer, modem, fax modem, etc.) for providing data and/or information to the operator or user of the central computer system 100 or to a third party. As known in the art, multiple components can also be connected to the CPU 111. ROM device 111B can include firmware and initialization software which can operate when power is applied to the system or when the system is reset, and can be read and executed directly from ROM device 111B or copied into memory devices 111A and executed therefrom. Input device 111C can be any combination of a keyboard, scanner, mouse, touch pad, audio input device, video input device, hard disk, CD ROM, graphic adapter, or the like.

Also connected to the central computer system 100 is a network interface 111D; a transmitter 111F; and a receiver 111G. The network interface 111D can connect the central computer system 100 to a network, e.g., the worldwide web, through a link 111D1 which is preferably a high speed link such as a cable broadband or DRL connection, a T1 or T3 line, or mobile 3G and/or 4G network. The transmitter 111F transmits data, information and/or signals to one or more producer computers 11B and consumer or individual computers 11A, and the receiver 111G receives one or more of data, information and/or signals from producer computers 11B and consumer or individual computers 11A. In one implementation, the transmitter 111F and the receiver 111G are components of the network interface 111D.

The central computer system 100 can also include one or more databases 111H which contain data and/or information pertaining to consumers such as individuals, groups, organizations, companies, and the like; and/or producers such as individuals, colleges, universities, employers, headhunters, recruiters, companies, etc. Non-limiting examples of data and information that can be stored in the databases 111H from a consumers perspective (consumer profiles) include name, age, gender, address, educational background (e.g., elementary school, middle school, high school, college, technical training, etc.), work experience and history, awards and/or certifications, achievements in sports and the arts (e.g., music, theatre, painting, ceramics, photography, etc.), languages spoken, school transcripts, test scores (e.g., ACF, SAT, MCAT, etc.), links to registrar's office and/or school databases, work samples, essays, letters of reference, audio clips, video clips, tax records, financial reports, intellectual property assets, litigation records, and/or any other relevant, pertinent and/or desired data and/or information. In one implementation, the consumer data and/or information (consumer profiles) can be stored in one or more consumer information repositories 111H¹ in one or more databases 111H.

The central computer system 100 can preserve confidentiality and anonymity by allowing the consumer to restrict access to any, some, or all of his/her or its data and/or information stored in database 111H. Thus, a consumer can control what, when, and how data and/or information is shared with a producers by requiring consumer's approval before granting producers view access to the data and/or information. Consumer approval can be achieved by requiring that prior to applying, enrolling, registering, etc., consumer input his/her login and password, e-mail address, cell phone number, pager number, and/or the like, which can be used to notify and confirm consumer's desire to grant view access to producers.

Confidentiality and anonymity can also be preserved by describing any, some, or all of consumers data and/or information generically (e.g., high school senior from Mid-West with 3.0 GPA and interest in electrical engineering) for a certain time and/or through a certain phase or phases of a process. The consumer can also completely restrict access to particular producers as well as list certain producers of particular interest. For example, the consumer data can include a list of producers to which consumer data will not be shared without the consumer's explicit consent. In addition, the consumer data can be used to automatically alert the consumer about requisitions from particular producers. For example, the consumer data and/or information can also include a list of schools, jobs, events, etc., for which he/she wishes to be notified.

Database 111H can also include data and/or information about producers (producer profiles). Such data and/or information can be include, but is not limited to, name (e.g., individual, company, school, employer, etc.), job offerings, loan offerings, entity size and location, benefit offerings, salary and/or compensation information, recruiters representing school, company and/or entity, academic programs offered, acceptance criteria, financial aid information, grant information, scholarship information, student organizations, clubs, sports programs, customer information, references, pictures of facilities, video clips, audio clips, links to registrar's office, and any other relevant, pertinent and/or desire data and/or information. In on implementation, the producer's data and/or information (producer profiles) can be stored in one or more producer information repositories 111H² in one or more databases 111H.

Database 111H can also include one or more requisitions options that producer's can select from to create one or more requisitions for some or all of its programs (academic, arts, etc.) and/or offerings (e.g., jobs, scholarships, loans, etc.). In one implementation, the requisitions are created by a producer selecting relevant, pertinent and/or desired criteria from a list of categorized requisition options. The requisition options are used to build a customized interface that can serve as a requisition and is linked to or integrated with a custom smart link. The requisitions and requisition options as well as the smart links can be stored in database 111H or in a data link repository 111H³ located in database 111H. The producer can build and design requisitions based upon its needs and/or desires for a particular program and/or offering. The producer can customize how the requisition is displayed or interfaced. The producer can input, customize, or create requisition options unique to its needs and/or desires.

Examples of requisition options used to create requisitions that are designed to target or pinpoint qualified consumers or candidates for programs and/or offerings include, but are not limited to, requirements such as personal (e.g., name, telephone number, address, social security number, date of birth, etc.), academics (e.g., high school diploma, GED, college degree (associates, bachelors, masters, doctorate, JD, etc.) in a particular field (e.g., chemistry, law, English, math, physics, et.); military; talents; mortgage; insurance; financials; job title (e.g., systems engineer, sales representative, college professor, etc.); years of work experience; employment sporting experience (football, swimming, basketball, etc.); geographic location (Midwest, Northeast, South, etc.); work schedules; salary range; languages (Spanish, English, German, etc.); grade point average; test scores (ACT, SAT, GMAT, GRE, etc.); technical experience (IT, word processing software, etc.); product and services; tax matters; contracts; employees; employee benefits; intellectual property; licenses; permits; litigation issues; real estate; physical assets; marketing; public relations; and any other relevant, pertinent and/or desired data and/or information. The requisition options can be categorized, for example, requisition options can be categorized in groups such as sports, education, work experience, finances, etc. There can also be sub-groups within each categorized group; for example, in the education category there can be sub-groups such as elementary, high school, college, grades, test scores and the like. The producer can select any available category and/or create or customize categories unique to its purpose or business. The requisition options can be selected, for example, by clicking on check boxes for each option of interest. In one implementation, the requisition options correspond with data fields in a consumer profile and/or a producer profile. In addition, the requisition options can also include customized questions that do not correspond to any preexisting field in a consumer profile or a producer profile.

The producer can link and/or integrate the requisition to one or more custom smart links that can be distributed for use via the internet and/or worldwide web onto the producer's web site and/or embedded into third party web sites (e.g., a webpage, blog, or profile on a social media site) where the producer has rights of authorship or a license to do so. The smart link can link to one or more requisitions in various ways. For example, the smart link can be a URL that identifies the requisition, a QR code that identifies the requisition, a QR code that contains the requisition, a telephone number that is used to access the requisition, etc. In one implementation, a telephone number can be used to access a voice application that asks the consumer various questions. Speech recognition can be used to determine a consumer's answer and to populate the consumer profile of the consumer.

A requisition can access one or more search engines, computer processing units, data link repositories. In addition, the interface of the requisition can be customized by the producer to facilitate more efficient access to targeted consumer data and/or information. Smart links allow efficient access to requisitions. Smart links can allow producers to turn static online forms into dynamic web apps that can be shared on websites where the code can be installed. Once multiple requisitions have been completed, the producer can view the completed requisitions. In one implementation, the completed requisitions are ranked based upon the criteria previously provided by the producer. In another implementation, a requisition contains fields from the consumer profile. In another implementation, a requisition can be targeted to producers by including fields from the producer profile. Thus, a producer can become a producer in that a producer can complete a requisition that incorporates data from the producer profile.

The interface that is displayed when the smart link is accessed can be in a variety of formats depending upon default parameters set by the central processing computer system, the producer, or both. The interface regarding the requisition can be customized by the producer thereby providing a means for the producer to decide how, when and/or where data and/or information will be displayed after the consumer has granted view access to their consumer profile.

In one implementation, an accessed smart link can capture and manage data and/or information as well as serve as an interface between different software programs and facilitate interaction between these programs, similar to the way user interface facilitates interaction between humans and computers. This feature can be effectuated using, for example an application programming interface (“code”) which can be created for applications, libraries, operating systems, etc., as a way of defining their “vocabularies” and resources, and/or request conventions (e.g. function-calling conventions). It may include specifications for routines, data structures, object classes, and protocols used to communicate between the consumer program and the implementer program of the API.

In one implementation, a producer can search the consumer data to identify a set of consumers. For example, consumer criteria can be associated with a requisition. Consumers whose consumer data matches the consumer criteria can be identified for products. The set of matching consumers can be provided to the producer. In addition, the number of consumers who do not match and what specific criteria is lacking can be provided. For example, consumers who meet 90% of the criteria but fail to meet a specific age requirement can be identified. The set of matching consumers can then be sent a smart link to one or more requisition forms of the producer. For example, producers can use a preference-based algorithm system that can examine consumer profiles to determine if the criteria set by the requisition has been met by some, all or none of the consumers that have profiles on the system, and provide a means for producers to invite and/or request consumers to apply for, enroll in, register for and/or request additional data and/or information from the consumers regarding one or more of its programs and/or offerings. Activation of the smart link by one or more the matching consumers can ask the consumer to grant view access of the consumer's data and/or information identified by the requisition.

Such a search can also be provided for consumers. For example, consumers can search through producers profiles, distributed custom smart links containing a requisition, and/or producer non-linked requisitions so that consumers can apply for, enroll in, register for and/or request data and/or information from producers about one or more programs and/or offerings. In one implementation these features are combined such that the smart link system is a bi-directional search engine for producers to search for and/or send invitations and/or requests to consumers who match the requisition criteria set by producers, and for the consumers to search for desired goods, services and/or information offered by producers.

Each activated smart link can be associated with a set of consumers that have been identified as relevant to the linked requisition. A producer can manage the set of consumers associated with their activated smart links. For example, a producer through a user account on the central processing computer system can modify, track, and manage each custom smart link separately thereby making the system easy to use.

Because consumer profiles, producer profiles, requisition options, and requisitions are created using pre-defined and/or recognized custom created fields, an activated smart links can be equipped with translation capabilities to provide real-time language translation. Thus, a completed requisition submitted by a consumer in English can be viewed real-time in Chinese by a Chinese speaking producer. The translation tools that can be utilized with the custom smart links can be any language translator program or software known in the art that can be modified, if need be, to provide the language translation capabilities.

Typical uses for custom smart links can include queries, data validation, application processing, registration processing, enrollment processing, and access control. For example, a requisition can include logic to validate user data. Validation can occur when a consumer submits data and/or can occur over the collection of received data. Validation can occur over one or more fields of the requisition. For example, numeric fields can be validated as containing a valid number. As another example, an address that is made up of multiple fields of a requisition, e.g., address, city, state, zip, can be validated. Validation can use third party services to validate data. For example, data can be formatted and submitted to a third party service that provides an indication that the data is valid. Such logic can also be integrated directly into a requisition.

Smart links can also be used to consolidate and centralize logic that was originally implemented in third party applications and databases. Therefore extensive or complex activities such as database queries and application logic can be integral components of activated smart links. For example, data and/or information regarding a consumer and/or producer that is located in, for example, an Excel® spreadsheet, Oracle®, Microsoft Access®, Microsoft Word®, Microsoft PowerPoint®, or Apple® product, and the like can be merged into and stored on data that is accessible by the activated smart link. In one implementation, the data located in an external application can be integrated into a user or producer profile. For example, text labels within a document, e.g., an HTML document, a word processing document, etc., can be matched to one or more text labels associated with a field of a requisition of an activated smart link. In one implementation, the one or more text labels are pre-stored text strings appearing in a plurality of different languages to identify matching data values in the external data.

To preserve confidentiality and/or anonymity every field of data and/or information described herein as being stored in the database 111H and/or otherwise used can be represented by a corresponding generic term. Thus, a consumer or producer can restrict access to any, some, or all of its data and/or information by being described initially in a generic manner (e.g., an Ivy League school in the northeast as opposed to being specifically named) so as to keep the true data and/or information hidden for a desired period of time and/or processing phase. Any of the data and/or information stored in the database 111H may have hyperlinks associated with it for directing a consumer to a separate and/or to a different source of data and/or information. The databases 111 can contain any other data and/or information which may be relevant, pertinent, useful, and/or desired. This can include data and/or information on attrition rates at colleges, companies, etc.; latest trends in certain professions, jobs and/or careers and the like.

The database 111H and the data and/or information stored within can be linked to producer computer 11B and/or consumer or individual computers 11A using any appropriate database management techniques. Updates to the data and/or information can be effectuated by inputs from consumers via the individual computer 11A and/or producers via the producer computer 11B and/or from any other information source at anytime.

Because access to real time, relevant, pertinent, and/or desired data and/or information is provided directly and/or indirectly from the databases 111 through one or more smart links the producers, after obtaining access approval, can get access to the latest information provided and stored by the consumers in the consumer information repository 111H¹. For example, if a consumer accepted access requests from 900 producers and the consumer changed or added a phone number, all 900 producers could, if desired, receive an alert notifying them of the phone number change, which is automatically updated for all producers. This eliminates or reduces a producer's need to make a request for updated information.

Each of the consumer or individual computer 11A and producer computer 11B can have the same or similar components and/or peripheral devices as the central computing system 100. The computer 11A and the computer 11B each can be network computers and/or computer systems used to communicate with the central computing system 100. Thus, each consumer or individual computer 11A and producer computer 11B can include RAM and ROM, each of which is connected to a CPU, an input device for entering data and/or commands, one or more of a keyboard, scanner, mouse, etc., a display device for displaying data and/or information to a user or operator, one or more transmitters and receivers, one or more databases, and output device for providing data and/or information to the operator, user, or third party, and the like.

In one implementation, the database 111H can have at least one producer profile that can be optionally stored in one or more producer information repositories 1111H²; at least one consumer profile that can be optionally stored in one or more consumer information repositories 111H¹; and at least one data link repository 111H³ having one or more requisitions.

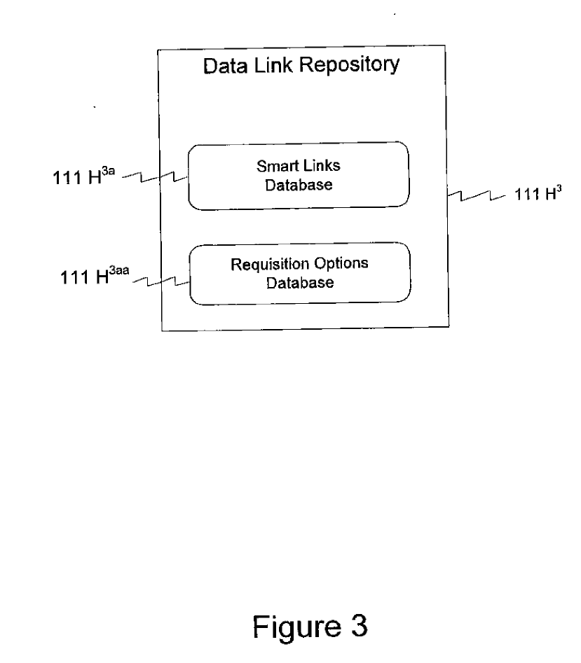

FIG. 3 illustrates a data link repository 111H³ in accordance with an illustrative implementation. The data link repository 111H³ can include one or more requisition option databases 111H^{3aa} and one or more smart link databases 111H^{3a}. Requisition option database 111H^{3aa} can have one or more requisition options and one or more requisitions, as previously described herein. The requisition options, once selected, form the data that will be collected when a consumer or producer completes the requisition. Once permission to access data is given, the requisition options can be automatically populated based upon one or more fields from a consumer profile or producer profile. In addition, a producer can specify criteria for a requisition that a consumer or producer must meet to qualify for a program (e.g., school, government grant, club, etc.) or offer (e.g., college admission, loan, job, scholarship, etc.). The requisition, once created, can remain in the data link repository 111H³ or requisition options database 111H^{3aa} unlinked until producer chooses to link and/or integrate it with one or more custom smart links. The producer can customize how data and/or information required and requested by the requisition through the smart link is displayed or interfaced. For example, the producer can specify in the requisition that the consumer's picture must appear in the upper left hand corner and the name, address and phone number must appear in the first 3 lines.

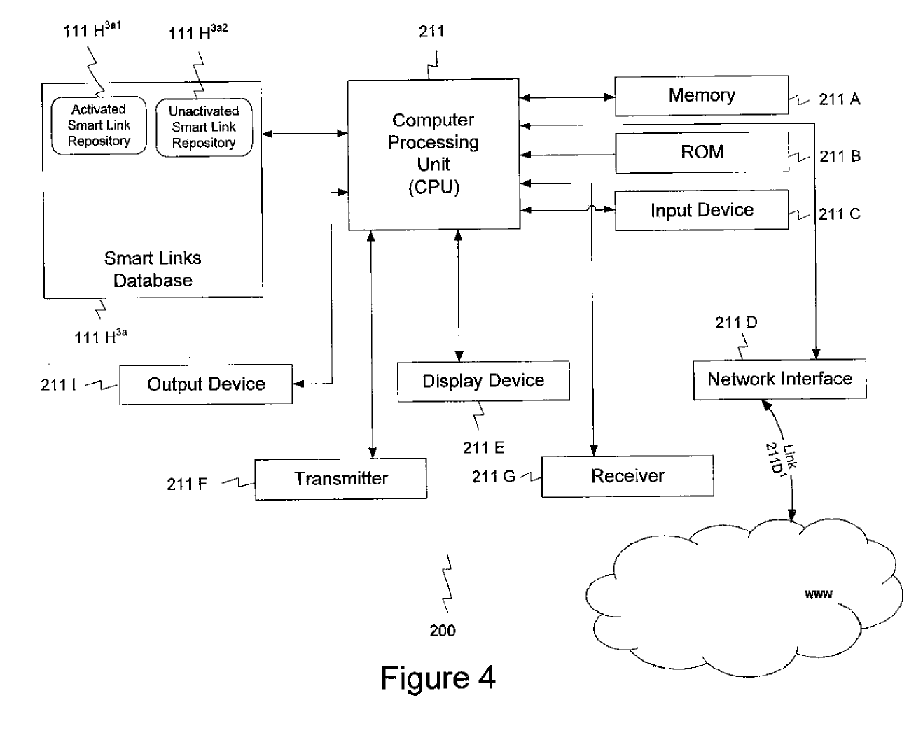

As seen in FIG. 4, a smart link processing system 200 can contain a smart link database 111H^{3a} which can have at least one activated smart link and which can be located in the database or in an activated smart link repository 111H^{3a1}. As previously described, an activated smart link is one that links to a requisition and has been made available to consumers on the producer's websites, blogs, etc., and/or on third party websites, blogs and the like. Smart link database 111H^{3a} can also have one or more unactivated (non-distributed) smart links 111H^{3a2} which the producer has chosen not to activate for whatever reason (e.g., waiting for clearance to offer the position). In on implementation, an unactivated smart link cannot be seen and/or accessed by a consumers.

Each smart link and corresponding requisition can include all of the components necessary to provide two-way transmission and reception, including the ability to execute transactions between producer and consumer. For example, communication between the consumer and producer can occur via the activated smart link. A producer can ask for additional information not requested in the initial requisition, which can be provided by the consumer.

The smart link processing system 200 can include multiple or a network processor system (CPU 211) where the processors share resources such as memory and storage; a multiple server system where independent servers operate in parallel and optionally having shared access to searchable databases, or a combination thereof. CPU 211 may be a microprocessor, microcomputer, minicomputer, macro-computer and/or a mainframe computer. Connected to CPU 211 is a memory device 211A which can be any suitable memory such as SRAM, DRAM, SDRAM, RDRAM, DDR, DRR-2, and the like. Also connected to CPU 211 is a read only memory device 211B (ROM); an input device 211C for entering data and/or commands into smart links system 200; a display device 211E for displaying data and/or information to a user or operator, and an output device 2111 (e.g., printer, modem, fax modem, etc.) for providing data and/or information to the operator or user of smart links database system 200 or to a third party. ROM device 211B may include firmware and initialization software such as which can operate when power is applied to the system or when the system is reset, and can be read and executed directly from ROM device 211B or copied into memory devices 211A and executed therefrom. Input device 211C can be any combination of a keyboard, scanner, mouse, touch pad, audio input device, video input device, hard disk, CD-ROM, graphics adapter, or the like.

Also connected to smart links database system 200 is a network interface 211D; a transmitter 211F; and receiver 211G. The network interface 211D connects computer system 200 to the worldwide web through a link 211D¹ which is preferably a high speed link such as a cable broadband or DSL connection or a T1 or T3 line, mobile 3G, or 4G network. Transmitter 211F transmits data, information and/or signals to one or more producer computers 11B and consumer or individual computers 11A. In one implementation, the transmitter 211F and the receiver 211G are components of the network interface 211D.

In various implementations, the smart link processing system 200 can also include one or more smart links databases 111H^{3a} which can contain one or more activated smart link repositories 111H^{3a1} that contain one or more activated smart links. The producer can create and store unactivated smart links for future use, for use as prototypes, and/or any other use that is desired by the procedure. Activated smart links are those that have been distributed as a live link to one or more of a producer's web sites, blogs, etc., and/or one or more third party sites (e.g., web site, blog, social media (e.g., Facebook®, etc.).

Smart links and requisitions can be used to perform a wide range of activities and business functions including, but not limited to, recruitment, and/or recruitment-related services; business offering (e.g., loans); goods and service offerings; and the like. Smart links and requisitions can provide such services in a manner which provides varying levels of confidentiality and/or anonymity.

In the case of recruitment and recruitment related services, producers such as individuals, independent contractors, schools, colleges, recruiters, and the like can post and/or list information regarding its programs and/or offerings; create one or more customized interfaces that provides a means for producers and consumers to share information as well as a means for consumers to apply, enroll and/or register for its programs and/or offerings without having to complete online forms; search for candidates that meet the criteria and/or requirements set forth in one or more of its requisitions made available by the smart link processing system 200; provide a quick and effective method for a consumers to apply, enroll, and/or register for one or more of its programs and/or offerings; invite or request a consumer to apply, register, and/or enroll in one or more of its program and/or offerings; and/or post and/or list information regarding jobs, employment positions, assignments, projects, admission process, acceptance criteria and/or process, approval process, loan programs, sports programs, school programs, as well as any other information and/or data by making the smart link database system 200 electronically available to consumers having interest in the subject of the requisitions linked to by at least one activated smart link on the smart link processing system 200.

With respect to the consumers, consumers can perform a wide range of activities and functions, including but not limited to posting, listing and/or storing data and/or information regarding themselves in the form of a consumer profile within database 111H of the central processing computer 100; searching, requesting and/or obtaining information and/or applying, registering, and/or enrolling for jobs, colleges, scholarships, sports programs, internships, assignments, positions, camps, etc., without having to complete online forms. Consumers can store and share relevant, pertinent, and/or desired data and/or information for use when applying, enrolling, purchasing, requesting data and/or information and/or registering for a program and/or offering by one or more producers. In addition, in some implementations, consumers can share their data and/or information confidentially and/or anonymously, including providing some, all, or none of the data and/or information. Consumers include individuals, students, college applicants, job applicants, prospective students, prospective employees, employees, independent contractors, etc.

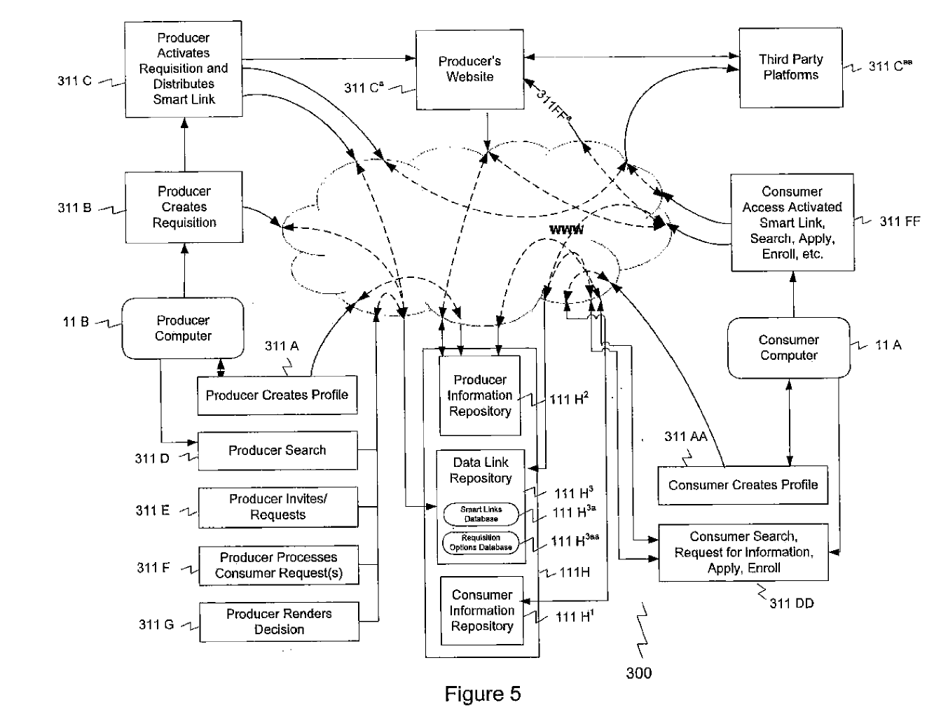

FIG. 5 illustrates how consumers and/or producers interact with smart links in accordance with an illustrative implementation. As shown in FIG. 5, consumers who possess desired credentials defined by a smart link requisition can apply, enroll, register, and/or request data and/or information from a producer without having to create or complete an on-line form. FIG. 5 also illustrates producers that can target, select, invite, communicate with and/or request qualified consumers who possess the credentials defined by the requisition of the custom smart link requisition to apply for a program or offering. FIG. 5 includes operations of various implementations. Additional, fewer, or different operations may be performed, depending on the particular implementation.

Operation of a computer system 300 can commence in an operation 311A wherein the producer accesses the central processing computer 11 via the producer's computer 11B, creates, and stores a profile on the system by entering data and/or information regarding name, size, location, programs and offering, video clips, audio clips and/or any other data and/or information that is prompted by the central processing computer 11 and/or that the producers deem relevant, pertinent, or desirable. The creation and storing operation 311A may be avoided if the producer has previously entered the data and/or information. The producer can also update and/or amend the stored data and/or information at any time. The data and/or information can be entered generically and/or specifically depending upon the producers desire to preserve confidentiality. The data and/or information (e.g., video clips) can also be entered by transferring, uploading and/or downloading into the central processing computer system 11. The data and/or information can be stored in database 111H, or in the producers information repository 111H² The data and/or information can be processed by central processing computer 11 so that it is stored and/or converted as generic data and/or information before being stored.

In an operation 311B, a producer can create one or more requisitions by selecting from a list of pre-defined requisition options located in data link repository 111H³, and/or requisition options database 111H^{3aa}. In addition, the producer can specify criteria a prospective consumer must or should have to be considered for a program or offering. The requisition options are pre-defined by the central processing computer system using established criteria that are common to particular industries. The producer can also create and implement customized requisition options that are specific or unique to its programs and/or offerings. The requisition options, and requisitions (once created), can be stored on the producers computer 11B, or in database 111H and/or one or more requisition options database 111H^{3aa} in data link repositories 111H³.

Once a requisition us created the producers can choose to activate a custom smart link by linking and/or integrating it with the requisition. The smart link can then be distributed via the producer's web site, via third party platforms, and/or other sites (e.g., social networks, blogs, websites of relevant schools, organizations, clubs, companies, etc.,). As another example, the smart link can be a QR code that can be published online or through printed materials. The activated smart link can be stored in the smart links database 111H^{3a} and/or in an activated smart link repository in the smart links database 111H^{3a}. Alternatively, the producer can choose not to link and/or integrate the requisition and the unactivated requisition can be stored in the data links repository 111H³ and/or in an unactivated smart link repository 111H^{3a2} that can be in the smart links database 111H^{3a} for future use. In one implementation, an activated smart link contains at least one linked and/or integrated requisition.

In an operation 311D, the producer can initiate a search for consumers by logging into the central processing computer 111H using secure login credentials and clicking one or more of its activated smart links to begin a search. The search will examine the consumer information repository 111H1, determine the number of consumers matching all of the criteria of the particular smart link requisition and report the results to the producer. The report can provides information that only describes the number of consumers that meet the requisition requirement and/or other generic information such as what part of the country the matching consumers are from.

In an operation 311E, the producer can choose to invite and/or request the consumers generated from the search to apply, enroll, and/or register, for its programs and/or offerings through a secure process previously described herein. The producer can also choose to request additional data and/or information from the consumers before sending an invitation. The producer can invite and/or request all of the qualified consumers or a subset. For example, if the search results revealed 50 consumers, the producer can choose to invite everyone. Alternatively, the producer can invite a subset (e.g., first 15, etc.). The producer can also modify the smart link requisition at anytime to obtain more targeted search results, for example, after obtaining a count for 50 qualified consumers the producer can modify the requisition to only those consumers who, for example, reside in a particular state.

In an operation 311F, the producer can respond to consumer requests and/or questions if any. In an operation 311G the producer can render a decision (e.g., accept, deny, waitlist, suspend communication), or make any other decision regarding consumer interest or lack thereof in one or more of its programs and/or offerings.

For consumers, access to the computer system 300 commences in an operation 311AA. A consumer can access the central processing computer 111H via the consumer's computer 11A, create, and store a profile on the system by entering data and/or information regarding name, address, date of birth, income requirements, years of education, schools of interest, sports programs of interest, awards achieved, credit and/or income information, video clips, audio clips and/or any other data and/or information that the consumer deems relevant, pertinent and/or desirable and/or that is required by a producer. The creation and storing of operation 311AA can be avoided if the consumer has previously entered the data and/or information. The consumer can also update and/or amend the stored data and/or information. The data and/or information can be entered generically and/or specifically depending upon the consumer's desire to preserve confidentiality. The data and/or information (e.g., video clips) can also be entered by uploading and/or downloading and/or storing onto the central processing computer 111H. The data and/or information can be stored generally in database 111H, or in the consumer repository 111H¹. The data and/or information can be processed by central processing computer 111H so that it is stored and/or converted as generic data and/or information before being stored.

The consumer can initiate a search, in an operation 311DD, for one or more producers by directly logging onto the central processing computer system using secure login credentials and inputting keywords and/or relevant and/or pertinent and/or desired search criteria. The consumer can choose to search the producers information repository 111H2 only for data and/or information that matches the keyword search criteria and the search results can be provided to the consumer via a consumer customizable interface. In this instance the consumer can search for data and/or information on or about the producers that may or may not relate or pertain to a requisition for a particular offering and/or program. Alternatively, the consumer can search for one or more activated smart links having at least one requisition in an area of interest by accessing the data link repository 111H³, and/or activated smart link repository 111H^{3a1}.

In an operation 311DD, the consumer can request data and information from a producer and both the consumer and producer can exchange data and/or information via the activated smart link. The consumer can apply, enroll and/or register for an offering and/or program when the consumer accesses one or more activated smart links.

Consumers can access activated smart links of one or more of the producers by one of several ways. One way can be by the consumer accessing the data link repository 111H³ and in particular one or more activated smart links through a search as described in the operation 311DD above. Another way can be by the consumer clicking on an activated smart link that has been placed by the producer onto an accessible web site, in an operation 311FF. Still another way can be by the consumer clicking on the activated smart link located on the producer's web site, in an operation 311FF^{a}. As another example, a user can access a smart link by scanning a QR code that includes the smart link or a reference to the smart link. After access the smart link, the consumer, can apply, enroll, and/or register for one or more offerings and/or programs of the producer through the activated smart link. The consumer can also communicate and/or exchange data and/or information with the producer directly through the activated smart link, as described in greater detail above.

As another example, the smart link system can be used in recruitment efforts by one or more schools. For example, schools (e.g., public and/or private primary, secondary and tertiary schools, colleges, universities, professional schools, art schools, performing art schools, design schools, technical schools, trade schools, and the like) can perform targeted and streamlined searches for prospective students who possess desired credentials defined by a smart link requisition. In one implementation, the school can already have a profile accessing central processing computer 11 via the schools computer. One or more requisitions can be created using the profile accessing central processing computer as described herein. In addition, existing requisitions can be amended. The requisitions can specify criteria that a prospective student must or should have to be considered for a program or offering (such as admission and/or acceptance to the school, program, class, scholarship, grant, or the like, provided by the school).

The school can select from requisition options already provided in the smart link repository and/or create and implement customized requisition options that are specific or unique to its programs and/or offerings to create its requisitions. Once the requisitions are created the school can link the requisition to one or more smart links. The school can create multiple interface buttons within an activated smart link for each degreed program (e.g., school of business, school of pharmacy, school of engineering). Additionally, the school can create different interface buttons within an activated smart link because different departments and/or divisions within the school may manage specific degreed programs differently. As part of the requisition creation, the school can provide criteria for one or more of the selected predefined fields, e.g., requisition options. Students that have completed the requisition options can then be ranked using the provided criteria. For example, students who meet all of the provided criteria can be ranked higher than students that only partially meet the criteria.

The school can also use a smart link requisition to search for students that match a particular set of requirements. For example, a school can search for prospective students from Midwestern United States or Europe with a GPA of 3.5 or above, SAT scores of 2000 or above, who are nationally ranked in golf, and have played in a band. Once the school is provided with a list of students meeting the criteria set forth in the smart link requisition the school can choose to invite and/or request none, some or all of the prospective students to apply, enroll, register for acceptance/admission, interview, visit, tour, meet with faculty etc. The school can also choose to request additional data and/or information from the prospective students before sending an invitation. The school can also modify the smart link requisition at anytime to obtain more target search results, for example, after obtaining the count for 50 qualified prospective students the school can modify the requisition to only those prospective students who, for example, reside in the state of Michigan.

Amongst other things readily discernable by those of ordinary skill in the art and/or described herein, the schools can render a decision (e.g., accept, deny, waitlist, suspend communication), or make any other decision regarding the prospective students interest or lack thereof in one ore more of its programs and/or offerings.

In another implementation, prospective students can search for schools using the smart link system. For example, prospective students (e.g., high school seniors, graduate students, and the like) can perform targeted and streamlined searches for prospective colleges, universities, trade schools, performing art schools, technical schools. A student can begin a search by accessing the central processing computer 11 via the student's computer. The student can then create and store a profile on the system by responding to prompts and entering data and/or information that the student deems relevant, pertinent and/or desirable and/or that is required by a school. The creation and storing of a student profile may be avoided if the student has previously entered the data and/or information. The student can also update and/or amend the stored data and/or information at any time. The data and/or information can be entered generically and/or specifically depending upon the student's desire to preserve confidentiality.

When looking for one or more potential schools, the prospective student can initiate a general search, by directly logging onto the central processing computer 11 using secure login credentials and inputting keywords, relevant information, pertinent information, and/or desired search criteria. In this regard the student is searching the school information repository only for data and/or information that matches the search criteria/keywords they provided. The results of the search can then be displayed to the student via a student customizable interface. In this instance the student's search for data and/or information on or about the schools may or may not relate or pertain to a particular offering and/or program as those generally found in an activated smart link. Based upon the search results, the student can communicate and/or exchange data and/or information with the schools without necessarily accessing a particular smart link, for example by sending an e-mail, telephoning, and the like.

Alternatively, the student can search the data link repository for one or more activated smart links of one or more schools in an area of interest by accessing the data link repository.

The student can access activated smart links of one or more of schools by one of several ways. One way is by the student accessing the data link repository through a search as described above. Another way is by the student accessing an activated smart link that has been placed by the producer onto an accessible web site. Still another way is by the student clicking on the activated smart link located on the school's web site. Yet another way is by the student responding to an activated smart link invitation and/or request from the school. After clicking on the activated smart link the student, can apply, enroll, and/or register for one or more offerings and/or programs of the school through the activated smart link. The student can also communicate and/or exchange data and/or information with the school directly through the activated smart link with or without having to apply, enroll and/or register for an offering and/or program.

The smart link system can preserve confidentiality, anonymity, and/or security of a student applying, enrolling, and/or registering for one or more offerings and/or programs of a school through the activate smart link by providing a means for the student to restrict access to any, some, or all of their data and/or information stored in databases. Thus, the student controls what, when, and how data and/or information is shared with a school by requiring the student's approval before granting the school view access to the data and/or information. The student's approval can be obtained before granting the school view access to the student's data and/or information by prompting and requiring the student to input his/her e-mail address, login and password, cell phone number, pager number, and/or the like, prior to beginning the application, enrollment, inquiry, and/or registration process. Once the email, cell phone, etc., is provided the student is then asked to confirm and/or grant view access to the schools some or all of their data and/or information. Confidentiality and anonymity can also be preserved by describing any, some, or all of the student's data and/or information generically (e.g., high school senior from Mid-West with 3.0 GPA and interest in electrical engineering) for a certain time and/or through a certain phase or phases of the process. The student can also completely restrict access to particular school as well as to allow access to a particular school. For example, the student's profile can include a list of schools, for which he/she or it wishes to be notified and who have been granted view access to some or all of the data in the student's profile.

After the student enters an email address or cell phone number, etc., a student customizable interface, can display various types of information to the student. For example, it can advise the student of missing information, if any, requested by the school and can prompt him/her to supply the information. It can show the percentage (e.g., 82% of information is available) of information accessible from the student information repository. It can also show the percentage (e.g., 50% acceptance rate) of probability of success upon submission of an application based on the requirements/criteria set by the school (e.g., SAT=>1280, (GPA=>3.4, ACT>=20). In one implementation, data related to requisition is not provided to the student until the student grants view access to some or all of the data fields reference by the requisition.

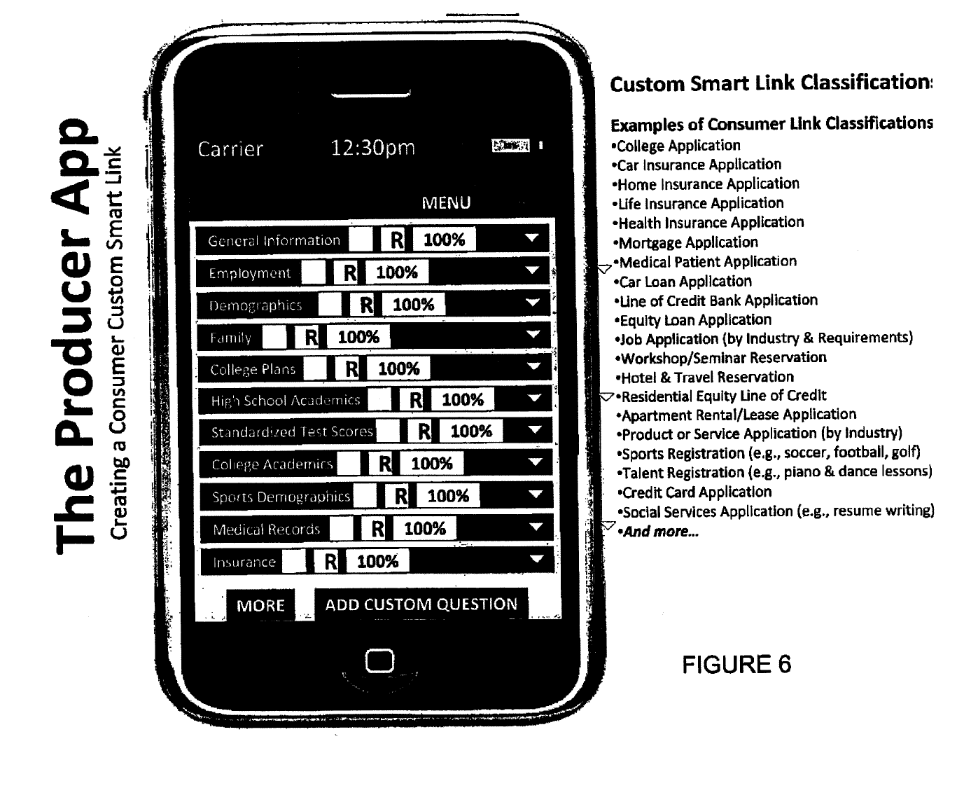

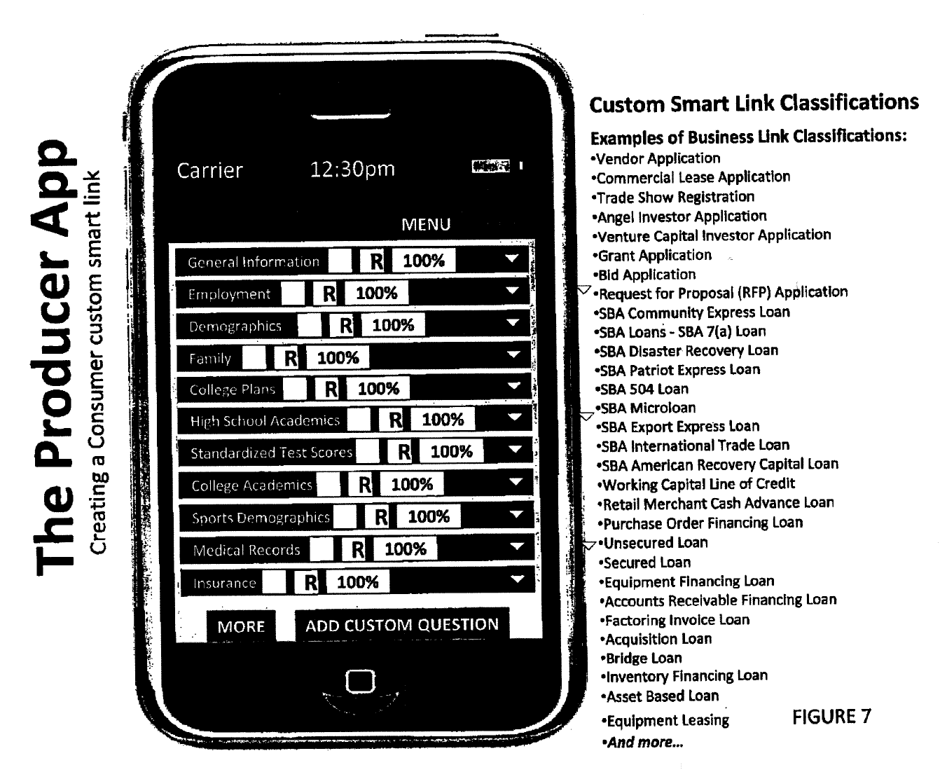

FIGS. 6 and 7 illustrates a sample Producer application interface with examples of consumer link classifications in accordance with an illustrative implementation. As is obvious to one of ordinary skill in the art based upon this description, various implementations can be used in other recruitment fields such as employment, clubs, and the like, the banking field, sport's field, social field, and any other activity and/or discipline where an application, enrollment and/or registration process is involved. Below is a non-limited listing of examples of implementations of consumer and producer application processes:

Examples of Consumer Link Classifications:
College Application
Car Insurance Application
Home Insurance Application
Life Insurance Application
Health Insurance Application
Mortgage Application
Medical Patient Application
Car Loan Application
Line of Credit Bank Application
Equity Loan Application
Job Application (by Industry & Requirements)
Workshop/Seminar Reservation
Hotel & Travel Reservation
Residential Equity Line of Credit
Apartment Rental/Lease Application
Product or Service Application (by Industry)
Sports Registration (e.g., soccer, football, golf)
Talent Registration (e.g. piano & dance lessons)
Credit Card Application
Social Services Application (e.g., and the like.

Examples of Producer (Business) Link Classifications:
Commercial Lease Application
Trade Show Registration
Vendor Application
Angel Investor Application
Venture Capital Investor Application
Grant Application
Bid Application
Request for Proposal (FRP) Application
SBA Community Express Loan
SBA Loans—SBA 7(a) Loan
SBA Disaster Recovery Loan
SBA Patriot Express Loan
SBA 504 Loan
SBA Microloan
SBA Export Express Loan
SBA International Trade Loan
SBA American Recovery Capital Loan
Working Capital Line of Credit
Retail Merchant Cash Advance Loan
Purchase Order Financing Loan
Unsecured Loan
Secured Loan
Equipment Financing Loan
Accounts Receivable Financing Loan
Factoring Invoice Loan
Acquisition Loan
Bridge Loan
Inventory Financing Loan
Asset Based Loan
Equipment Leasing and the like.

As described above, smart links can be used in a network environment or over any communication network. Various computing device make an exemplary network, such as a central processing computer system or server computer system, one or more individual or consumer computers and one or more producer computers. Each of the computers may communicate with any and all of the other computers. Each of the central processing computers, the individual/consumer computers, and/or the producer computers can include any and/or all components, peripherals, hardware, and/or software as described herein. The central processing computer may also include or be linked to one or more databases, storage devices and/or memory devices for storing, manipulating and/or managing any or all of the data and/or information described as being utilized, and/or which may be utilized.

While this specification contains many specific implementation details, these should not be construed as limitations on the scope of any implementations or of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, various implementations have been described. Other implementations are within the scope of the following claims. In some cases, the actions recited in the claims can be performed in a different order and still achieve desirable results.

What is claimed is:

1. A non-transitory computer-readable medium having instructions stored thereon, that when executed by a computing device cause the computing device to perform operations comprising:
receiving, from a user, user data associated with one or more fields of a user profile associated with the user, wherein the user profile comprises a plurality of predefined fields;
receiving, from a producer, a request to create a requisition comprising requisition fields, wherein the requisition fields include one or more of the plurality of predefined fields of the user profile;
receiving a request for the requisition via a smart link from the user;
determining requisition user data from the user profile corresponding to the requisition fields, wherein the requisition user data comprises a portion of the received user data;
sending the requisition and the requisition user data to the user;
receiving, from the user, a permission indication for each of the requisition fields; and
providing to the producer the requisition user data based upon the received permission indications.

2. The non-transitory computer-readable medium of claim 1, wherein the operations further comprise:
receiving additional data from the user in response to sending the requisition to the user;
updating the user profile with the additional data; and
providing to the producer the additional data.

3. The non-transitory computer-readable medium of claim 1, wherein the operations further comprise translating the requisition data from a first language to a second language prior to providing the requisition data to the producer.

4. The non-transitory computer-readable medium of claim 1, wherein the operations further comprise:
receiving matching criteria associated with the requisition;
searching for a plurality of user profiles using the matching criteria; and
providing the plurality of user profiles to the provider.

5. The non-transitory computer-readable medium of claim 4, wherein the operations further comprise sending an invitation to the requisition to each user associated with each of the plurality of user profiles.

6. The non-transitory computer-readable medium of claim 1, wherein the smart link comprises a uniform resource locator.

7. The non-transitory computer-readable medium of claim 1, wherein the smart link comprises a QR code.

8. The non-transitory computer-readable medium of claim 1, wherein the smart link comprises a telephone number.

9. The non-transitory computer-readable medium of claim 1, wherein the operations further comprise validating data of one or more predefined fields of the user profile.

10. The non-transitory computer-readable medium of claim 9, wherein the validating data of one or more predefined fields of the user profile comprises:
sending data of two or more predefined fields of the user profile to a remote server; and
receiving an indication of validity of the data of the two or more predefined fields of the user profile.

11. A system comprising:
one or more processors configured to:
receive, from a user, user data associated with one or more fields of a user profile associated with the user, wherein the user profile comprises a plurality of predefined fields;
receive, from a producer, a request to create a requisition comprising requisition fields, wherein the requisition fields include one or more of the plurality of predefined fields of the user profile;
receive a request for the requisition via a smart link from the user;
determine requisition user data from the user profile corresponding to the requisition fields;
send the requisition and the requisition user data to the user;
receive, from the user, a permission indication for each of the requisition fields; and
provide to the producer the requisition user data based upon the received permission indications.

12. The system of claim 11, wherein the one or more processors are further configured to:
receive additional data from the user in response to sending the requisition to the user;
update the user profile with the additional data; and
provide to the producer the additional data.

13. The system of claim 11, wherein the one or more processors are further configured to translate the requisition data from a first language to a second language prior to providing the requisition data to the producer.

14. The system of claim 11, wherein the one or more processors are further configured to:
receive matching criteria associated with the requisition;
search for a plurality of user profiles using the matching criteria; and
provide the plurality of user profiles to the provider.

15. The system of claim 14, wherein the one or more processors are further configured to send an invitation to the requisition to each user associated with each of the plurality of user profiles.

16. A method comprising:
receiving, from a user, user data associated with one or more fields of a user profile associated with the user, wherein the user profile comprises a plurality of predefined fields;
receiving, from a producer, a request to create a requisition comprising requisition fields, wherein the requisition fields include one or more of the plurality of predefined fields of the user profile;
receiving a request for the requisition via a smart link from the user;
determining, using a processor, requisition user data from the user profile corresponding to the requisition fields, wherein the requisition user data comprises a portion of the received user data;
sending the requisition and the requisition user data to the user;
receiving, from the user, a permission indication for each of the requisition fields; and
providing to the producer the requisition user data based upon the received permission indications.

17. The method of claim 16, further comprising:
receiving additional data from the user in response to sending the requisition to the user;
updating the user profile with the additional data; and
providing to the producer the additional data.

18. The method of claim 16, further comprising translating the requisition data from a first language to a second language prior to providing the requisition data to the producer.

19. The method of claim 16, further comprising:
receiving matching criteria associated with the requisition;
searching for a plurality of user profiles using the matching criteria; and
providing the plurality of user profiles to the provider.

20. The method of claim 19, further comprising sending an invitation to the requisition to each user associated with each of the plurality of user profiles.
